(19) United States
(12) Patent Application Publication
(10) Pub. No.: US 2025/0224982 A1
(43) Pub. Date: Jul. 10, 2025

(54) Queue Management for Scalable Input/Output Virtualization (SIOV) Devices

(71) Applicant: Advanced Micro Devices, Inc., Santa Clara, CA (US)

(72) Inventors: Anthony Thomas Gutierrez, Seattle, WA (US); Stephen Alexander Zekany, Redmond, WA (US); Ali Arda Eker, Bellevue, WA (US)

(73) Assignee: Advanced Micro Devices, Inc., Santa Clara, CA (US)

(21) Appl. No.: 18/408,849

(22) Filed: Jan. 10, 2024

(51) Int. Cl. G06F 9/48

(52) U.S. Cl. CPC G06F 9/4881

(57) ABSTRACT

In accordance with the described techniques, a scalable input/output virtualization (SIOV) device includes multiple hardware queues, backend hardware resources, and a command processor running scheduling firmware. The scheduling firmware selects a shared work queue of multiple shared work queues managed by the scheduling firmware from which to dispatch tasks based on one or dispatch policies. In addition, the scheduling firmware selects a hardware queue of the multiple hardware queues in which to enqueue the tasks based on one or more queue policies. Further, the scheduler dispatches the tasks from the shared work queue to the hardware queue, and the tasks are read from the hardware queue by the backend hardware resources for execution.

### BACKGROUND

Virtualization is foundational to cloud computing, and enables creation of multiple independent execution environments (e.g., virtual machines and containers) in which applications and operating systems run. More specifically, input/output (I/O) virtualization involves creating multiple instances of a single physical I/O device (e.g., a network controller, a storage controller, or an accelerator), and exposing the multiple instances (e.g., virtual I/O devices) across multiple virtual machines, containers, or applications. Scalable input/output virtualization (SIOV) is an I/O virtualization paradigm that allows “direct-path” operations to be run directly on hardware, and “intercepted-path” operations to be emulated using software. SIOV provides improved resource sharing scalability, as compared to other I/O virtualization paradigms, e.g., Single Root I/O Virtualization (SR-IOV)

### BRIEF DESCRIPTION OF THE DRAWINGS

FIG. 1 is a block diagram of a non-limiting example system to implement queue management for SIOV devices.

FIG. 2 depicts an example of managing shared work queues and hardware queue in accordance with one or more dispatch policies and one or more queue policies.

FIG. 3 depicts a procedure in an example implementation of queue management for SIOV devices.

### DETAILED DESCRIPTION

### Overview

A system includes a host processor communicatively coupled to an SIOV device. The SIOV device includes a command processor running scheduling firmware (e.g., a scheduler), and the scheduler includes multiple shared work queues. Broadly, shared work queues in the context of SIOV are work submission interfaces capable of accepting tasks (e.g., processing kernels) from multiple different software processes (e.g., operating systems, applications, virtual machines, and containers) running on the host processor. Further, the SIOV device includes backend hardware resources, which in accordance with the described techniques, include hardware queues and processing elements of a processing element array. SIOV enables various different partitioning schemes, including allocating shared work queues to particular software processes, allocating hardware queues to particular shared work queues, allocating groupings (partitions) of processing elements to particular hardware queues, and the like.

Software processes in cloud computing environments have quality of service (QoS) demands that are to be met by the system. In accordance with SIOV, the backend hardware resources are shared to a greater extent (e.g., by more software processes) than conventional virtualization techniques, which improves scalability and flexibility but increases contention for shared resources and scheduling overhead. Due to this, it is paramount for the scheduler to implement lightweight and efficient scheduling policies to meet QoS demands for the software processes of the system.

To do so, the host processor communicates one or more dispatch policies and one or more queue policies to the SIOV device. Broadly, the dispatch policies control which shared work queue of the multiple shared work queues from which the scheduler is to dispatch tasks. Further, the queue policies control which hardware queue of the multiple hardware queues into which tasks are enqueued. Thus, at a given point in time, the scheduler selects a shared work queue to service based on the dispatch policies, selects a hardware queue in which to enqueue tasks based on the queue policies, and dispatches tasks from the selected shared work queue to the selected hardware queue. Furthermore, the processing elements allocated to the selected hardware queue read and execute the tasks.

Accordingly, the dispatch policies control dispatch of tasks from the shared work queues to prioritize servicing high priority shared work queues and/or high priority tasks (e.g., critical path tasks) within the shared work queues, avoid hardware queue pollution, and/or evenly distribute service to the multiple shared work queues. Further, the queue policies control utilization of the backend hardware resources to increase shared resource utilization, improve load balancing, and reduce data movement between hardware queues. By providing multiple levels of queues (e.g., a first level of shared work queues, and a second level of hardware queues), the scheduler is able to decouple the selection of which shared work queue to service from the selection of which hardware queue in which to enqueue tasks.

Therefore, the dispatch policies do not impact the shared resource utilization, load balancing, and data movement controlled by the queue policies. Similarly, the queue policies do not impact the distribution of service, hardware queue pollution control, and prioritization of shared work queues controlled by the dispatch policies. For at least these reasons, the described techniques efficiently service (e.g., by meeting QoS demands of) a larger number of software processes than conventional virtualization techniques, enabling increased utilization of the scalability associated with SIOV-configured devices.

In some aspects, the techniques described herein relate to an SIOV device, comprising multiple hardware queues, backend hardware resources, and a command processor running scheduling firmware, the scheduling firmware configured to select a shared work queue of multiple shared work queues managed by the scheduling firmware from which to dispatch tasks based on one or more dispatch policies, select a hardware queue of the multiple hardware queues in which to enqueue the tasks based on one or more queue policies, and dispatch the tasks from the shared work queue to the hardware queue, the tasks being read from the hardware queue by the backend hardware resources for execution.

In some aspects, the techniques described herein relate to an SIOV device, wherein the one or more dispatch policies include a prioritization policy, and to select the shared work queue based on the prioritization policy, the scheduling firmware is configured to select the shared work queue based on an order of priority assigned to the multiple shared work queues.

In some aspects, the techniques described herein relate to an SIOV device, wherein the one or more dispatch policies include an exclusivity policy, and to select the shared work queue based on the exclusivity policy, the scheduling firmware is configured to dispatch the tasks exclusively from the shared work queue unless one or more conditions are satisfied.

In some aspects, the techniques described herein relate to an SIOV device, wherein the one or more dispatch policies include a distribution policy, and to select the shared work queue based on the distribution policy, the scheduling firmware is configured to decrement task counters associated with the multiple shared work queues responsive to the tasks being dispatched from the multiple shared work queues, select the shared work queue based on a task counter of the shared work queue having a non-zero value, and reset the task counters to a predefined value responsive to the task counters each being decremented to zero.

In some aspects, the techniques described herein relate to an SIOV device, wherein the one or more dispatch policies include a throttling policy, and to select the shared work queue based on the throttling policy, the scheduling firmware is configured to throttle dispatch of the tasks from one or more shared work queues based on a number of in-flight tasks of the one or more shared work queues exceeding a threshold number, and select the shared work queue based on the number of in-flight tasks of the shared work queue being less than or equal to the threshold number.

In some aspects, the techniques described herein relate to an SIOV device, wherein the one or more dispatch policies include a dependency policy in which the tasks include metadata specifying a number of dependent tasks depending from the tasks, and to select the shared work queue in accordance with the dependency policy, the scheduling firmware is configured to select the shared work queue based on the shared work queue including a task that is ready for dispatch and has at least a threshold number of dependent tasks depending from the task.

In some aspects, the techniques described herein relate to an SIOV device, wherein the one or more queue policies include a queue sharing policy specifying whether the multiple hardware queues are shared among the multiple shared work queues or reserved for a particular shared work queue, and the hardware queue is selected based on the hardware queue being reserved for the shared work queue.

In some aspects, the techniques described herein relate to an SIOV device, wherein the one or more queue policies include a batch sampling policy, and to select the hardware queue based on the batch sampling policy, the scheduling firmware is configured to sample a batch of hardware queues, collect performance metrics from hardware queues in the batch, and select the hardware queue from the batch of hardware queues based on the performance metrics.

In some aspects, the techniques described herein relate to an SIOV device, wherein the one or more queue policies include a dequeue rate policy, and to select the hardware queue based on the dequeue rate policy, the scheduling firmware is configured to select the hardware queue based on a dequeue rate of the hardware queue exceeding an enqueue rate of the hardware queue by at least a threshold amount.

In some aspects, the techniques described herein relate to an SIOV device, wherein the one or more queue policies include a locality policy, and to select the hardware queue based on the locality policy, the scheduling firmware is configured to select the hardware queue based on a task that is ready for dispatch from the shared work queue being dependent on one or more tasks that have been dispatched to the hardware queue.

In some aspects, the techniques described herein relate to an SIOV device, wherein the shared work queue is a priority queue, and to dispatch the tasks from the shared work queue, the scheduling firmware is configured to dispatch the tasks in an order of priority assigned to the tasks by the priority queue.

In some aspects, the techniques described herein relate to an SIOV device, wherein the shared work queue is a first-in-first-out (FIFO) queue.

In some aspects, the techniques described herein relate to an SIOV device, wherein the shared work queue includes the tasks enqueued in queue order from different software processes that are assigned an order of priority, and to dispatch the tasks from the shared work queue, the scheduling firmware is configured to dispatch the tasks in the order of priority of the different software processes and out of the queue order.

In some aspects, the techniques described herein relate to a system, including an SIOV device including multiple shared work queues and multiple hardware queues, and a host processor to communicate one or more dispatch policies and one or more queue policies to the SIOV device, the one or more dispatch policies controlling which shared work queue of the multiple shared work queues from which tasks are dispatched, the one or more queue policies controlling which hardware queue of the multiple hardware queues in which to enqueue the tasks, and submit the tasks to the multiple shared work queues, thereby directing the SIOV device to dispatch the tasks from the multiple shared work queues to the multiple hardware queues in accordance with the one or more dispatch policies and the one or more queue policies.

In some aspects, the techniques described herein relate to a system, wherein the one or more dispatch policies include a prioritization policy indicating an order of priority assigned to the multiple shared work queues, the prioritization policy instructing the SIOV device to dispatch the tasks from a shared work queue having a highest relative priority among one or more shared work queues having at least one task that is ready for dispatch.

In some aspects, the techniques described herein relate to a system, wherein the one or more dispatch policies include a distribution policy instructing the SIOV device to decrement task counters associated with the multiple shared work queues responsive to the tasks being dispatched from the multiple shared work queues, dispatch the tasks from shared work queues having a non-zero value, and reset the task counters to a predefined value responsive to the task counters of the multiple shared work queues each being decremented to zero.

In some aspects, the techniques described herein relate to a system, wherein the one or more dispatch policies include a throttling policy instructing the SIOV device to throttle dispatch of the tasks from one or more shared work queues based on a number of in-flight tasks of the one or more shared work queues exceeding a threshold number.

In some aspects, the techniques described herein relate to a system, wherein the host processor includes a compiler configured to generate a task graph including the tasks and dependencies between the tasks, and to submit the tasks, the host processor is configured to submit the task graph directing the SIOV device to schedule the tasks of the task graph based on the dependencies.

In some aspects, the techniques described herein relate to a system, wherein the host processor includes a compiler configured to receive a static task graph including the tasks and dependencies between the tasks, and map the tasks of the static task graph to respective hardware queues based on the dependencies, the one or more queue policies including a compiler-driven policy directing the SIOV device to dispatch the tasks to the respective hardware queues to which the tasks are mapped.

In some aspects, the techniques described herein relate to a method, comprising receiving, by a scalable input/output virtualization (SIOV) device, tasks for submission to multiple shared work queues of the SIOV device, throttling, by the SIOV device, dispatch of the tasks from at least one shared work queue based on a number of in-flight tasks of the at least one shared work queue exceeding a threshold number, dispatching, by the SIOV device, the tasks from a non-throttled shared work queue to a hardware queue of the SIOV device, and dispatching, by the SIOV device, the tasks from the hardware queue to a processing element array of the SIOV device for execution.

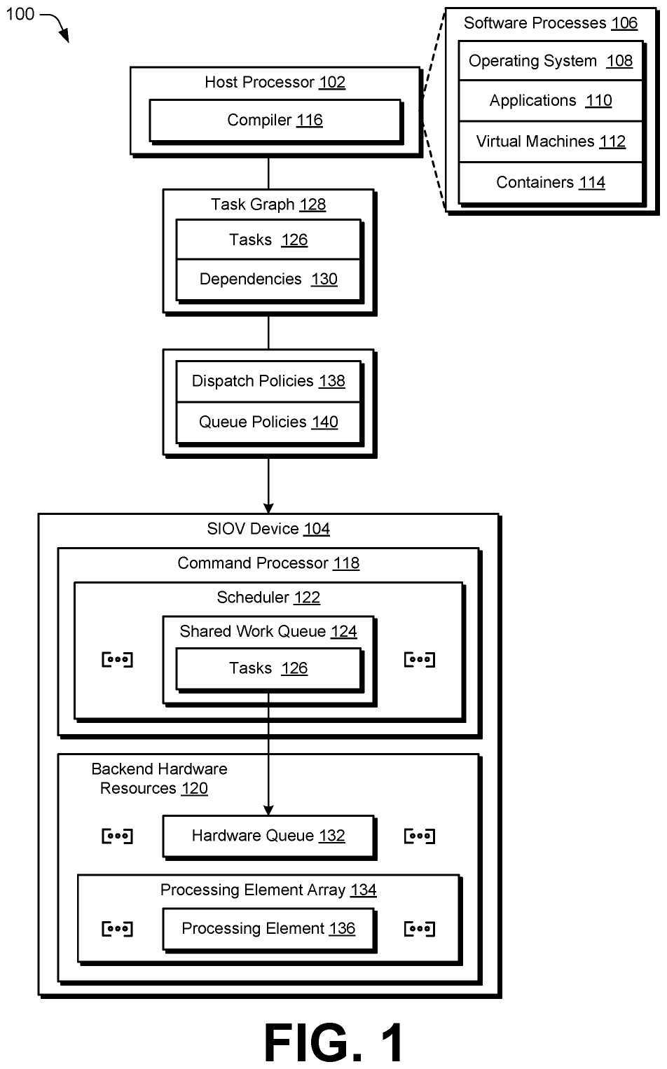

FIG. 1 is a block diagram of a non-limiting example system 100 to implement queue management for SIOV devices. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

In accordance with the described techniques, the system 100 includes a host processor 102 and a scalable input/output virtualization (SIOV) device 104, which are coupled to one another via a wired or wireless connection. Example wired connections include, but are not limited to, buses (e.g., a data bus), interconnects, traces, and planes. The host processor 102 is an electronic circuit that reads, translates, and executes operations of software processes 106 running on one or more cores of the host processor 102, e.g., an operating system 108, applications 110, virtual machines 112, and containers 114. Although examples are described herein in which the software processes 106 are running on the host processor 102, it is to be appreciated that the software processes 106 are capable of running on any one or more of a variety of agents in the system 100, e.g., GPUs, artificial intelligence accelerators, or any other type of accelerator devices. Examples of the host processor 102 include, but are not limited to, a central processing unit (CPU), a field-programmable gate array (FGPA), and an application-specific integrated circuit (ASIC). As shown, the host processor 102 includes a compiler 116, which represents software that runs on the host processor 102 to translate (e.g., compile) the software processes 106 from a high-level source programming language into machine code, byte code, or some other low-level programming language that is executable by hardware components of the system 100.

The SIOV device 104 is an input/output (I/O) device configured in accordance with a protocol specified by the Scalable Input/Output Virtualization Technical Specification. Examples of the SIOV device 104 include network controllers, storage controllers, and accelerator devices, such as graphics processing units (GPUs), digital signal processors (DSPs), vision processing units (VPUs), and cryptographic accelerators, to name just a few. Broadly, virtualization enables system software (e.g., hypervisors and/or container engines) to create multiple isolated execution environments, such as virtual machines 112 or containers 114, in which applications 110 and operating systems 108 run. More specifically, I/O virtualization refers to the virtualization of I/O devices, thereby creating multiple virtual instances backed by a single physical I/O device (e.g., referred to as virtual I/O devices) and exposing the multiple virtual I/O devices across multiple operating systems 108, applications 110, virtual machines 112, or containers 114.

In accordance with SIOV, accesses between virtual machines 112 and containers 114 and an I/O device are facilitated via “direct-path” operations or “intercepted-path” operations. Direct-path operations are mapped directly to the underlying hardware of the I/O device, while intercepted-path operations are emulated using software, e.g., the virtual I/O devices. Furthermore, SIOV enables software processes 106 having different address domains to share hardware resources of the I/O device using different abstractions. For example, operating systems 108 and applications 110 access hardware resources of an I/O device using system calls, while virtual machines 112 and containers 114 access hardware resources of an I/O device via virtual device interfaces. For these reasons, SIOV enables increased scalability and flexibility in comparison to other hardware-assisted I/O virtualization paradigms, such as single root I/O virtualization (SR-IOV).

As shown, the SIOV device 104 includes a command processor 118 and backend hardware resources 120, which are coupled to one another via wired or wireless connections. In one or more examples, the command processor 118 is an integrated circuit, such as a CPU, embedded in a same computer chip that houses the SIOV device 104. Further, the command processor 118 is illustrated as including a scheduler 122, which in one or more instances, is implemented as firmware on the command processor 118.

The scheduler 122 is configured to manage shared work queues 124, which are work submission interfaces that are capable of accepting tasks 126 from multiple different software processes 106 running on the host processor 102, e.g., operating systems 108, applications 110, virtual machines 112, and containers 114. More specifically, the software processes 106 submit tasks 126 (e.g., processing kernels) to the shared work queues 124 for processing by the SIOV device 104, e.g., using the backend hardware resources 120. Although capable of accepting tasks 126 from different software processes 106, one or more of the shared work queues 124 are allocated individually to a single software process 106 and accept work solely from the single software process 106.

In one or more implementations, the tasks 126 are included as part of a task graph 128, which includes nodes that are tasks 126 and edges that indicate dependencies 130 between the tasks. In variations, the task graph 128 and the dependencies 130 are generated by the compiler 116. Additionally or alternatively, a static task graph 128 including the dependencies 130 is received as part of source code of a software process 106. In order to properly execute a task graph 128, dependent tasks 126 (i.e., child tasks) are to be processed after antecedent tasks 126 (i.e., parent tasks) on which the dependent tasks 126 depend. In other words, a task 126 of a task graph 128 that includes dependencies on other tasks is processable after the dependencies of the task 126 are resolved. Submission of a task graph 128 instructs the scheduler 122 to schedule the tasks 126 of the task graph 128 in a way that complies with the dependencies 130. To do so, in one or more implementations, the compiler 116 inserts barriers in between tasks 126 based on the dependencies 130 of the task graph 128. Broadly, the barriers enforce the dependencies 130 by causing the scheduler 122 to stall task dispatch from a shared work queue 124 until the dependencies 130 of a pending task 126 are resolved. Although depicted as included as part of a task graph 128, it is to be appreciated that one or more tasks 126 are independently submittable (e.g., not tethered to a task graph 128) in variations.

Notably, the backend hardware resources 120 are hardware components specific to the SIOV device 104. In accordance with the described techniques, the backend hardware resources 120 include a plurality of hardware queues 132, and a processing element array 134 having a plurality of processing elements 136. However, the SIOV device 104 includes additional types of backend hardware resources 120 in variations, including but not limited to command/status registers, references to in-memory queues, local memory of the SIOV device, fixed function logic devices, and direct memory access engines, to name just a few. Although the tasks 126 are depicted and described herein as being read by the processing element array 134 from the hardware queues 132 for execution, it is to be appreciated that the tasks 126 are dispatchable from the hardware queues 132 to any one or more of a variety backend hardware resources 120 without departing from the spirit or scope of the described techniques.

Given the above, tasks 126 are submitted by the software processes 106 running on the host processer 102 to the shared work queues 124. Further, the scheduler 122 dispatches tasks that are “ready” for dispatch (e.g., independent tasks 126 or tasks 126 having all dependencies 130 resolved) to the hardware queues 132. Moreover, tasks 126 are read and executed by the processing elements 136 of the processing element array 134.

Different partitioning schemes are enabled via SIOV and the described techniques. In one example, shared work queues 124 are either shared by multiple software processes 106, or allocated individually to single software processes 106. In another example, hardware queues 132 are either shared by multiple shared work queues 124, or are reserved for enqueueing tasks from just one shared work queue 124.

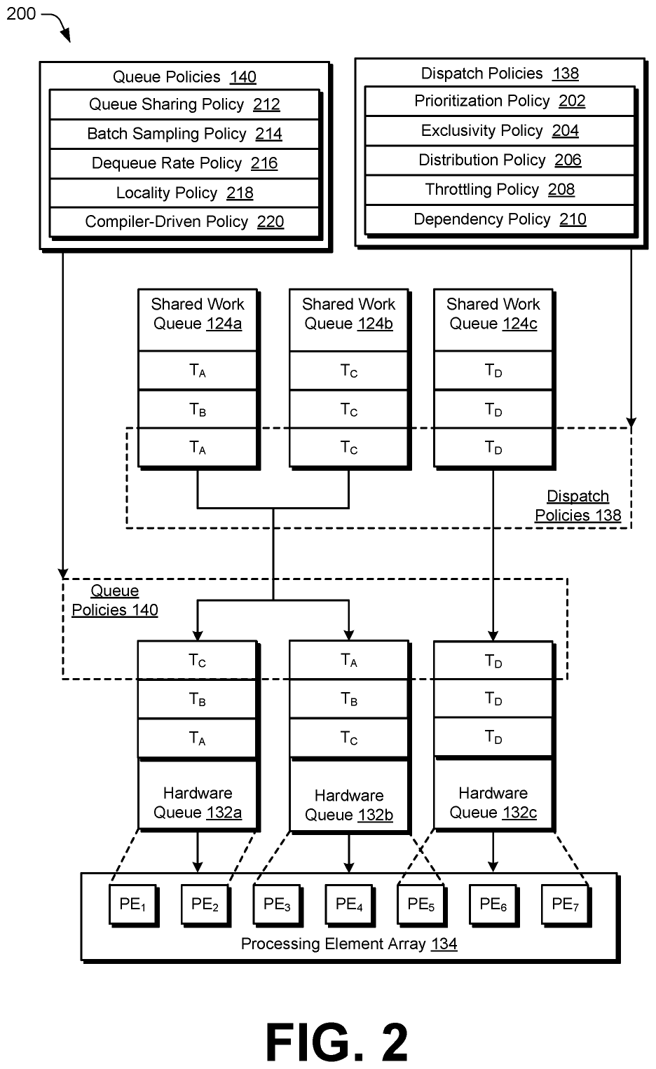

In one or more additional examples, the scheduler 122 is multi-threaded, and each thread of execution of the scheduler 122 manages different sets of shared work queues 124 and hardware queues 132. As further discussed below with reference to FIG. 2, shared work queues 124 are prioritized, and as such, the different threads of execution separately manage respective sets of low priority shared queues 124, but collectively manage a set of high priority shared work queues 124. By enabling the high priority shared work queues 124 to be serviced by multiple threads of execution, the high priority shared work queues 124 are serviced faster than the low priority shared work queues 124.

In various additional examples, the processing element array 134 is divided into groupings of one or more processing elements 136 and one or more groupings are assigned to process tasks 126 of just one hardware queue 132, one or more groupings are assigned to process tasks 126 of a subset of hardware queues 132, and/or one or more groupings are assigned to process tasks of all hardware queues 132 of the system 100. In at least one additional or alternative example, one or more hardware queues 132 are overprovisioned to the shared work queues 124, and/or one or more groupings of processing elements 136 are overprovisioned to the hardware queues 132, thereby improving resource allocation.

Notably, software processes 106 in cloud computing environments have quality of service (QoS) demands that are to be met by the system 100. In accordance with SIOV, the backend hardware resources 120 are shared to a greater extent (e.g., by more software processes 106) than conventional virtualization techniques, which improves scalability and flexibility but increases contention for shared resources and scheduling overhead. Due to this, it is paramount for the scheduler 122 to implement lightweight, scalable, and efficient scheduling policies to maintain QoS parameters for the software processes 106 of the system 100.

Accordingly queue management for SIOV devices is described herein. In accordance with the described techniques, the host processor 102 communicates one or more dispatch policies 138 and one or more queue policies 140 to the SIOV device 104. Broadly, the dispatch policies 138 control which shared work queue 124 of the multiple shared work queues 124 from which the scheduler 122 is to dispatch tasks 126. Further, the queue policies 140 control which hardware queue 132 of the multiple hardware queues 132 into which tasks 126 are enqueued. At a given point in time, therefore, the scheduler 122 selects a shared work queue 124 to service based on the dispatch policies 138, selects a hardware queue 132 in which to enqueue tasks 126 based on the queue policies 140, and dispatches tasks 126 from the selected shared work queue 124 to the selected hardware queue 132.

As further discussed below, the dispatch policies 138 control dispatch of tasks 126 from the shared work queues 124 to prioritize servicing high priority shared work queues 124 and/or high priority tasks (e.g., critical path tasks) within the shared work queues 124, avoid hardware queue 132 pollution, and/or evenly distribute service to the multiple shared work queues 124. Further, the queue policies 140 control utilization of the backend hardware resources 120 to increase shared resource utilization, improve load balancing, and reduce data movement between the hardware queues 132, as further discussed below. By providing multiple levels of queues (e.g., a first level of shared work queues 124, and a second level of hardware queues 132), the scheduler 122 is able to decouple the selection of which shared work queue 124 to service from the selection of which hardware queue 132 in which to enqueue tasks 126.

Therefore, the dispatch policies 138 do not impact the shared resource utilization, load balancing, and data movement controlled by the queue policies 140. Similarly, the queue policies 140 do not impact the dispatch rate, distribution of service, hardware queue pollution control, and prioritization of shared work queues 124 controlled by the dispatch policies 138. In addition and as further discussed below, the operations to implement the dispatch policies 138 are carried out with latency that is independent of the number of shared work queues 124 of the system 100. Due to this, the dispatch policies 138 do not hinder the scalability offered by the SIOV device 104. For at least these reasons, the described techniques efficiently service (e.g., by meeting QoS demands of) a larger number of software processes than conventional virtualization techniques using scalable scheduling policies, enabling increased utilization of the scalability associated with the SIOV device 104.

FIG. 2 depicts an example 200 of managing shared work queues and hardware queues in accordance with one or more dispatch policies and one or more queue policies. The example 200 includes shared work queues 124a, 124b, 124c having tasks 126 denoted with notation T_{X}, in which “X” represents a distinct software process 106. For instance, T_{A} is a task submitted by software process A, T_{B} is a task submitted by software process B, T_{C} is a task submitted by software process C, and T_{D} is a task submitted by software process D. As shown, the shared work queue 124a accepts tasks 126 from two different software processes 106 (e.g., A and B). In contrast, the shared work queue 124b accepts tasks 126 solely from software process C, and the shared work queue 124c accepts tasks 126 solely from software process D.

In addition, the example 200 includes hardware queues 132a, 132b, 132c, and groupings of processing elements 136 of a processing element array 134 allocated thereto. For instance, PE₁ and PE₂ are allocated to servicing hardware queue 132a, PE₃. PE₄ and PE₅ are allocated to servicing hardware queue 132b, and PE₅, PE₆ and PE₇ are allocated to servicing hardware queue 132c. Notably, PE₅ is overprovisioned and services both hardware queue 132b and hardware queue 132c. As shown, the dispatch policies 138 control which shared work queue 124 tasks 126 are dispatched from, while the queue policies 140 control which hardware queue 132 tasks 126 are dispatched to.

In one or more implementations, the dispatch policies 138 include a prioritization policy 202. Broadly, the prioritization policy 202 instructs the scheduler 122 to dispatch tasks 126 from the shared work queues 124 based on an order of priority assigned to the shared work queues 124. By way of example, the host processor 102 communicates an indication of the order of priority along with the prioritization policy 202. In variations, the order of priority is partial or complete. In one example, a complete order of priority ranks all shared work queues 124 of the system from highest to lowest priority. In this example, the scheduler 122 selects, as the shared work queue 124 from which to dispatch tasks 126, the shared work queue 124 having the highest relative priority among shared work queues 124 with at least one ready task. In another example, a partial order of priority ranks a subset of shared work queues 124 from highest priority to lowest priority, while remaining shared work queues 124 are marked as low priority. If at least one shared work queue 124 in the subset includes a ready task, the scheduler 122 selects, from among shared work queues 124 in the subset that include a ready task, the shared work queue 124 having the highest relative priority. If there are no shared work queues 124 in the subset that include a ready task 126, the scheduler 122 dispatches tasks 126 from a low priority shared work queue 124.

In one or more implementations, the dispatch policies 138 include an exclusivity policy 204. Broadly, the exclusivity policy 204 instructs the scheduler 122 to dispatch tasks 126 exclusively from a particular shared work queue 124 until one or more conditions are met. By way of example, the host processor 102 communicates an indication of the particular shared work queue 124 and the one or more conditions along with the exclusivity policy 204. During time periods in which the particular shared work queue 124 is exclusively serviced, other shared work queues 124 accept, but do not dispatch, tasks 126.

In one example, the one or more conditions dictate that the particular shared work queue 124 is serviced until all tasks 126 of a high priority task grouping or a high priority task graph 128 in the particular shared work queue 124 have been dispatched to the hardware queues 132. In another example, the particular shared work queue 124 is serviced exclusively in response to the queue reaching an upper threshold capacity (e.g., 50% full), and the one or more conditions dictate that the particular shared work queue 124 is serviced until the queue reaches a lower threshold capacity, e.g., 10% full or drained entirely. In yet another example, the one or more conditions dictate that the particular shared work queue 124 is serviced exclusively until the tasks 126 of a particular software process 106 are drained from the particular shared work queue 124. In one or more examples, the prioritization policy 202 and/or the exclusivity policy 204 indirectly prioritize individual software processes 106 by prioritizing shared work queues 124 that are allocated individually to a single software process 106, e.g., shared work queue 124c.

In one or more implementations, the dispatch policies 138 include a distribution policy 206. Broadly, the distribution policy 206 controls even distribution of service to the shared work queues 124. In accordance with the distribution policy 206, the scheduler 122 is configured to maintain task counters for each of the shared work queues 124 of the system. Further, a task counter is decremented each time a task 126 is dispatched from a corresponding shared work queue 124. For example, the scheduler 122 decrements the task counter of the shared work queue 124a (e.g., by one) in response to the scheduler 122 dispatching a task 126 from the shared work queue 124a. Further, the distribution policy 206 dictates that the tasks 126 are dispatched solely from shared work queues 124 having non-zero task counters. Once the task counters of each of the shared work queues 124 are decremented to zero (or below a threshold non-zero value), the scheduler 122 resets the task counters to a predefined value. Accordingly, the distribution policy 206 ensures that lower priority shared work queues 124 are not neglected.

Notably, task graphs 128 often encounter the problem of head-of-queue blocking, which is the notion that a task 126 at the head of a queue (e.g., the shared work queue 124) that is waiting for a dependency 130 to be resolved blocks (and delays execution of) tasks 126 that are deeper in the queue and ready for dispatch. To resolve this issue, task graphs 128 often include chains of dependent tasks 126 with independent tasks 126 dispersed in between. In this way, independent tasks 126 are dispatchable while the dependent tasks 126 wait for dependencies 130 to be resolved.

Chains of dependent tasks 126 often include critical path tasks 126 since delaying a parent task delays execution of all tasks depending therefrom. Accordingly, the chains of dependent tasks 126 are often higher priority tasks than the dispersed independent tasks 126. Since the dispersed independent tasks 126 are dispatched sequentially with minimal delay from the shared work queues 124, the independent tasks 126 often pollute the hardware queues 132 and delay the high priority, dependent tasks 126. This problem is further exacerbated by the notion that a single hardware queue 132 often services multiple shared work queues 124, and as such, independent tasks 126 rapidly dispatched from one shared work queue 124 delay execution of tasks 126 dispatched from a different shared work queue 124.

To solve this problem, the dispatch policies 138 include a throttling policy 208 in one or more implementations. The throttling policy 208 dictates that the scheduler 122 maintains a counter of in-flight tasks 126 for each of the shared work queues 124. Here, in-flight tasks 126 are tasks 126 that have been dispatched from the shared work queues 124, but have not yet been executed by the processing element array 134. By way of example, the scheduler 122 increments the counter of shared work queue 124a (e.g., by one) responsive to dispatching a task 126 therefrom, and decrements the counter of the shared work queue 124a (e.g., by one) responsive to receiving a completion signal indicating that the task 126 has been executed. In accordance with the throttling policy 208, the scheduler 122 throttles dispatch of tasks 126 from shared work queues 124 having at least a threshold number of in-flight tasks 126. Stated alternatively, the scheduler 122 is configured to select a shared work queue 124 from which to dispatch tasks based on the shared work queue 124 having fewer than a threshold number of in-flight tasks 126.

Here, “throttling” dispatch of tasks 126 from a shared work queue 124 includes either preventing dispatch of tasks 126 from the shared work queue 124 entirely, or specifying a reduced number of tasks 126 that are dispatchable from the shared work queue 124 within a defined time interval. By throttling task dispatch from shared work queues 124 with a large number of in-flight tasks, the scheduler 122 (1) alleviates low priority, independent tasks 126 of a particular shared work queue 124 delaying high priority, dependent tasks 126 of the particular shared work queue 124, and (2) alleviates rapidly dispatched independent tasks of a shared work queue 124 from delaying tasks of a different, higher priority shared work queue 124.

In one or more implementations, the dispatch policies 138 include a dependency policy 210. In accordance with the dependency policy 210, the tasks 126 include metadata specifying a number of dependent tasks 126 that depend from the tasks 126. In various implementations, the metadata is generated by the compiler 116 as part of the code compiling process. The scheduler 122 is configured to read the metadata from ready tasks 126 of the shared work queues 124. Further, the scheduler 122 selects, as the shared work queue 124 from which to dispatch tasks 126, a shared work queue 124 including a ready task 126 having at least a threshold number of dependent tasks 126 depending therefrom. Since delaying a parent task 126 delays execution of all tasks 126 depending therefrom, a parent task 126 having a large number of dependent tasks 126 is often characterized as a critical path task 126. Thus, the dependency policy 210 prioritizes servicing shared work queues 124 having critical path tasks 126.

In one or more implementations, the dependency policy 210 is paired with a queue policy 140 dictating that one or more fast-path hardware queues 132 enqueue solely critical path tasks 126. For example, the scheduler 122 is configured to dispatch tasks 126 having at least a threshold number of dependent tasks 126 (as indicated by the metadata) to the fast-path hardware queues 132. Since the fast-path hardware queues 132 solely enqueue critical path tasks 126, queueing delay is reduced for the fast-path hardware queues 132. Accordingly, this combination of policies increases computational efficiency of critical path tasks 126, thereby increasing overall throughput for the software processes 106.

It should be noted that each of the dispatch policies 138 are implementable as standalone policies, or are combinable with one or more other dispatch policies 138. In at least one example, the distribution policy 206 and/or the throttling policy 208 serve to eliminate various shared work queues 124 from consideration for servicing. For instance, the distribution policy 206 prevents shared work queues 124 with task counters decremented to zero from being serviced, and/or the throttling policy 208 prevents shared work queues 124 with at least a threshold number of in-flight tasks from being serviced. Meanwhile, the prioritization policy 202 serves to select the highest priority shared work queue 124 from the shared work queues 124 that have not been eliminated from consideration by the distribution policy 206 and the throttling policy 208. Additionally or alternatively, the distribution policy 206 and/or the throttling policy 208 correspond to the one or more conditions of the exclusivity policy 204, and the particular shared work queue 124 is serviced as long as the particular shared work queue 124 is not eliminated from consideration for servicing by the policies 206, 208. Additionally or alternatively, the scheduler 122 temporarily assigns a higher priority to a shared work queue 124 having a ready task 126 with at least a threshold number of tasks 126 in accordance with the dependency policy 210. Further, the scheduler 122 dispatches tasks 126 from the shared work queues 124 in accordance with the prioritization policy 202 considering the shared work queue 124 having the adjusted priority.

Furthermore, each of the dispatch policies 138 described above are carried out by evaluating counters (e.g., in accordance with the distribution policy 206 and the throttling policy 208), compiler generated metadata (e.g., in accordance with the dependency policy 210), and ordering of shared work queues 124 (e.g., in accordance with the prioritization policy 202 and the exclusivity policy 204). None of these policies iterate over the entries in each of the shared work queues 124, and as such, the operational latency to carry out the described dispatch policies 138 is independent of the number of shared work queues 124 in the system. In other words, the described dispatch policies 138 are highly scalable in accordance with SIOV.

Moving on to the queue policies 140. In one or more implementations, the queue policies 140 include a queue sharing policy 212. Broadly, the queue sharing policy 212 indicates which hardware queues 132 are shared among multiple shared work queues 124, and/or which hardware queues 132 are reserved for a particular shared work queue 124. In the illustrated example, for instance, the hardware queue 132c is a non-shared queue reserved for enqueueing tasks 126 from the shared work queue 124c, while the hardware queues 132a, 132b are shared queues which enqueue tasks 126 from multiple shared work queues 124a, 124b. To carry out the queue sharing policy 212, the scheduler 122 dispatches tasks 126 from a shared work queue 124 to a hardware queue 132 allocated to the shared work queue 124. When the shared work queue 124a is selected in accordance with the dispatch policies 138, for instance, the scheduler 122 dispatches tasks 126 to either of the hardware queues 132a, 132b. However, when the shared work queue 124c is selected in accordance with the dispatch policies 138, the scheduler 122 dispatches tasks 126 solely to the hardware queue 132c.

In one or more implementations, the queue policies 140 include a batch sampling policy 214. In accordance with the batch sampling policy 214, the scheduler 122 is configured to sample a batch of hardware queues 132. In a system having many hardware queues 132 (e.g., tens of thousands or hundreds of thousands of hardware queues 132), for instance, the scheduler 122 selects five hardware queues 132 for inclusion in a batch. Furthermore, the scheduler 122 collects performance metrics from the sampled hardware queues 132. In at least one example, the performance metrics include queue occupancy, e.g., how many tasks 126 are enqueued in the sampled hardware queues 132. In yet another example, the performance metrics include expected queue latency, e.g., expected time to execute the tasks 126 that are enqueued in the sampled hardware queues 132. In this example, the tasks 126 include metadata (e.g., generated by the compiler 116 as part of the code compiling process) indicating expected latency of the tasks 126. Thus, to determine the queue latency for a respective hardware queue 132, the scheduler 122 accumulates the latency of each individual task 126 enqueued in the respective hardware queue 132.

Furthermore, the scheduler 122 selects the hardware queue 132 from the batch based on the performance metrics, e.g., the hardware queue 132 having the lowest queue occupancy or the lowest expected queue latency. By batch sampling the hardware queues 132 in the described manner, the described techniques enable selection of a hardware queue 132 having a relatively low occupancy or a relatively low expected queue latency without evaluating all hardware queues 132 in the system. Accordingly, the batch sampling policy 214 is highly scalable in accordance with SIOV.

It is to be appreciated that other selection ordering policies are implementable, such as round robin hardware queue 132 selection, without departing from the spirit or scope of the described techniques. Additionally or alternatively, a round robin selection policy is combined with the batch sampling policy 214 in which the batches are selected in accordance with a round robin approach, and individual hardware queues 132 are selected for task enqueuing based on the batch sampling policy 214.

In one or more implementations, the queue policies 140 include a dequeue rate policy 216. In accordance with the dequeue rate policy 216, the scheduler 122 is configured to calculate, for each of the hardware queues 132, an enqueue rate and a dequeue rate over a time interval. The enqueue rate of a respective hardware queue 132 captures a number of tasks 126 enqueued in the respective hardware queue 132 over the time interval, while the dequeue rate captures a number of tasks 126 dequeued from the respective hardware queue 132 to the processing element array 134 for execution over the time interval. In accordance with the dequeue rate policy 216, the scheduler 122 selects a hardware queue 132 in which to enqueue tasks 126 based on the dequeue rate of the hardware queue 132 exceeding the enqueue rate of the hardware queue 132 by at least a threshold amount.

In various implementations, the dequeue rate policy 216 is used in combination with the above-described batch sampling policy 214. For example, the scheduler 122 selects a hardware queue 132 for inclusion in a batch to be sampled based on the hardware queue's dequeue rate exceeding the hardware queue's enqueue rate by at least the threshold amount. Consider another example in which the batches are sampled in a round-robin manner and a particular hardware queue 132 is to be included as part of a particular batch to be sampled. In this example, the enqueue rate of the particular hardware queue 132 exceeds the dequeue rate of the particular hardware queue 132 by a threshold amount, and as such, the scheduler 122 excludes the particular hardware queue 132 from the batch. In summary, the dequeue rate policy 216 serves to prioritize hardware queues 132 that dequeue tasks 126 faster than tasks 126 are enqueued, and skips or de-prioritizes hardware queues 132 that enqueue tasks 126 faster than tasks 126 are dequeued, thereby improving load balancing among the hardware queues 132.

In one or more implementations, the queue policies 140 include a locality policy 218. In accordance with the locality policy 218, the scheduler 122 is configured to select a hardware queue 132 based on a selected shared work queue 124 including a ready task 126 that depends on a parent task 126 that has been dispatched to the hardware queue 132. In an example, the shared work queue 124b is selected based on the dispatch policies 138. Further, a ready task 126 at the head of the shared work queue 124b is dependent on a task 126 that has already been dispatched to the hardware queue 132a. Thus, in this example, the scheduler 122 dispatches the ready task 126 from the shared work queue 124b to the hardware queue 132a.

In various implementation scenarios, groupings of processing elements 136 (e.g., PE₁ and PE₂) are partitioned for exclusively servicing a particular hardware queue 132a, as shown. Further, the groupings of processing elements 136 each include a local memory, e.g., PE₁ and PE₂ share local memory. By dispatching chains of dependent tasks 126 to a same hardware queue 132, the locality policy 218 improves data locality and reduces data movement since the data relied on by the dependent tasks 126 (e.g., and produced by processing parent tasks 126) is already present in the local memory of the processing element grouping.

In one or more implementations, the queue policies 140 include a compiler-driven policy 220. In accordance with the compiler-driven policy 220, the compiler 116 receives a static task graph 128 from a software process 106. Broadly, the dependencies 130 of the static task graph 128 are fixed at compile time, and do not change during execution of the software process 106. At compile time, the compiler 116 maps the tasks 126 of the static task graph 128 to respective hardware queues 132 using a static scheduling algorithm and/or a cost model. In other words, the compiler 116 determines, at compile time, which hardware queue 132 each of the tasks 126 are to be dispatched to. Factors considered by the cost model and/or the static scheduling algorithm include, but are not limited to, dependencies 130, task execution time, energy consumption, communication overhead, and the like. In accordance with the compiler-driven policy 220, the scheduler 122 dispatches tasks 126 of the static task graph 128 to the hardware queues 132 to which the tasks 126 are mapped by the compiler 116. In one or more examples, the mapping of the tasks 126 to the hardware queues 132 determined by the compiler 116 overrides other queue policies 140 for static task graphs 128.

Like the dispatch policies 138, each of the queue policies 140 are implementable as standalone policies or are combinable with one or more other queue policies 140. In addition, different dispatch policies 138 are assignable to different shared work queues 124, while different queue policies 140 are assignable to different hardware queues 132. By way of example, a majority of the queues 124, 132 are assigned a baseline set of policies 138, 140, while a subset of queues 124, 132 are assigned specialized sets of policies 138, 140.

Furthermore, different policies 138, 140 are assignable by the host processor 102 at runtime. For example, the host processor 102 includes counters and/or registers that track performance of various QoS metrics, e.g., queueing delay of tasks 126 in the queues 124, 132, occupancy/capacity of the queues 124, 132, latency of execution of the tasks 126, and so on. Using the counters and/or registers, the host processor 102 determines that a certain QoS demand is not met for a certain software process 106, and in response, the host processor 102 changes the policies 138, 140 assigned to the queues 124, 132 that are allocated to the software process 106 in order to meet the QoS demand.

It should be noted that the data structure of the shared work queues 124 differ in accordance with the described techniques. For instance, one or more shared work queues 124 correspond to priority queues in which tasks 126 are assigned an order of priority. Broadly, a priority queue is an array, linked list, heap, or binary tree structure, in which elements having a highest priority are dequeued from the priority queue efficiently, e.g., in O(1) time complexity for various priority queue structures. For shared work queues 124 having a priority queue data structure, the tasks 126 are dispatched from the shared work queue 124 in the order of priority indicated by the priority queue. Additionally or alternatively, one or more shared work queues 124 correspond to first-in-first-out (FIFO) queues, in which tasks 126 are dispatched based on an order in which the tasks 126 are enqueued into the shared work queues 124. In one non-limiting example, shared work queues 124 marked as high priority (e.g., in accordance with the prioritization policy 202) are priority queues, while shared work queues 124 marked as low priority (e.g., in accordance with the prioritization policy 202) are FIFO queues.

Rather than dispatching tasks based on a queue order of the underlying data structure of the shared work queue 124, the scheduler 122 implements a search-based task selection policy in one or more examples. In accordance with the search-based task selection policy, a shared work queue 124a includes tasks from different software processes 106 (e.g., software process A and software process B), and the tasks are enqueued in queue order. Further, the different software processes 106 are assigned an order of priority, and the tasks 126 are dispatched from the shared work queue 124a based on the order of priority of the software processes 106 (and out of queue order) by searching the shared work queue 124a for tasks of a higher priority software process 106. Additionally or alternatively and in accordance with the dependency policy 210, the scheduler 122 searches for critical path tasks 126 (e.g., having the metadata indicating at least a threshold number of dependent tasks 126), and dispatches the critical path tasks 126 out of queue order.

It should be noted that migration between different computing devices is supported by the described techniques. For example, the described policies 138, 140 do not rely on characteristics of device-specific and/or vendor-specific configurations. Due to this, the described techniques enable migration between two devices having compatible scheduling firmware (e.g., the scheduler 122) by transferring the implemented policies 138, 140 to a new device.

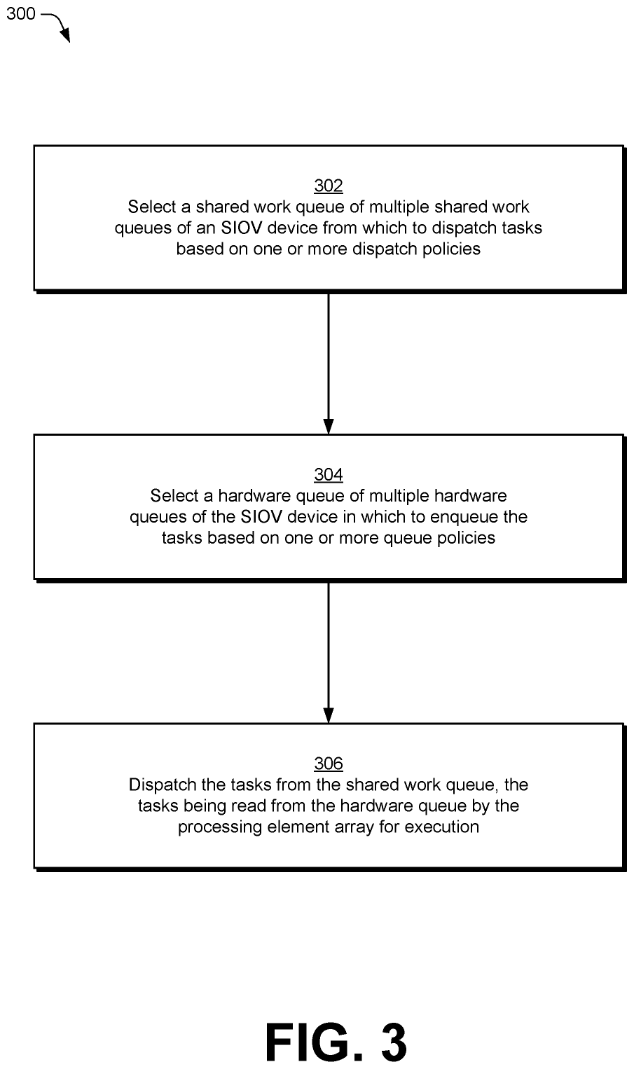

FIG. 3 depicts a procedure 300 in an example implementation of queue management for SIOV devices. In the procedure 300, a shared work queue from which to dispatch tasks is selected from multiple shared work queues of an SIOV device based on one or more dispatch policies (block 302). By way of example, the SIOV device 104 includes a plurality of shared work queues 124 which accept tasks 126 from one or more software processes 106. Further, the SIOV device 104 receives one or more dispatch policies 138 (e.g., the prioritization policy 202, the exclusivity policy 204, the distribution policy 206, the throttling policy 208, and/or the dependency policy 210) from the host processor 102 controlling which shared work queue 124 tasks are dispatched from. Given this, the scheduler 122 selects a particular shared work queue 124 to service based on the one or more dispatch policies 138 received.

A hardware queue in which to enqueue tasks is selected from multiple hardware queues of the SIOV device based on one or more queue policies (block 304). By way of example, the SIOV device 104 includes a plurality of hardware queues 132 which enqueue tasks from the shared work queues 124. Further, the SIOV device 104 receives one or more queue policies (e.g., the queue sharing policy 212, the batch sampling policy 214, the dequeue rate policy 216, the locality policy 218, and/or the compiler-driven policy 220) from the host processor 102 controlling which hardware queue 132 tasks 126 are dispatched to. Given this, the scheduler 122 selects a particular hardware queue 132 in which to enqueue tasks 126 based on the one or more queue policies 140 received.

The tasks are dispatched from the shared work queue to the hardware queue, and the tasks are read from the hardware queue by the processing element array for execution (block 306). For example, the scheduler 122 dispatches tasks 126 from the selected shared work queue 124 to the selected hardware queue 132. Furthermore, the processing elements 136 allocated to servicing the hardware queue 132 read and execute the tasks 126.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host processor 102, the SIOV device 104, the compiler 116, the command processor 118, the backend hardware resources 120, the scheduler 122, the hardware queues 132, the processing element array 134, and the processing elements 136) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A scalable input/output virtualization (SIOV) device, comprising:
multiple hardware queues;
backend hardware resources; and
a command processor running scheduling firmware, the scheduling firmware configured to:
select a shared work queue of multiple shared work queues managed by the scheduling firmware from which to dispatch tasks based on one or more dispatch policies;
select a hardware queue of the multiple hardware queues in which to enqueue the tasks based on one or more queue policies; and
dispatch the tasks from the shared work queue to the hardware queue, the tasks being read from the hardware queue by the backend hardware resources for execution.

2. The SIOV device of claim 1, wherein the one or more dispatch policies include a prioritization policy, and to select the shared work queue based on the prioritization policy, the scheduling firmware is configured to select the shared work queue based on an order of priority assigned to the multiple shared work queues.

3. The SIOV device of claim 1, wherein the one or more dispatch policies include an exclusivity policy, and to select the shared work queue based on the exclusivity policy, the scheduling firmware is configured to dispatch the tasks exclusively from the shared work queue unless one or more conditions are satisfied.

4. The SIOV device of claim 1, wherein the one or more dispatch policies include a distribution policy, and to select the shared work queue based on the distribution policy, the scheduling firmware is configured to:
decrement task counters associated with the multiple shared work queues responsive to the tasks being dispatched from the multiple shared work queues;
select the shared work queue based on a task counter of the shared work queue having a non-zero value; and
reset the task counters to a predefined value responsive to the task counters each being decremented to zero.

5. The SIOV device of claim 1, wherein the one or more dispatch policies include a throttling policy, and to select the shared work queue based on the throttling policy, the scheduling firmware is configured to:
throttle dispatch of the tasks from one or more shared work queues based on a number of in-flight tasks of the one or more shared work queues exceeding a threshold number; and
select the shared work queue based on the number of in-flight tasks of the shared work queue being less than or equal to the threshold number.

6. The SIOV device of claim 1, wherein the one or more dispatch policies include a dependency policy in which the tasks include metadata specifying a number of dependent tasks depending from the tasks, and to select the shared work queue in accordance with the dependency policy, the scheduling firmware is configured to select the shared work queue based on the shared work queue including a task that is ready for dispatch and has at least a threshold number of dependent tasks depending from the task.

7. The SIOV device of claim 1, wherein the one or more queue policies include a queue sharing policy specifying whether the multiple hardware queues are shared among the multiple shared work queues or reserved for a particular shared work queue, and the hardware queue is selected based on the hardware queue being reserved for the shared work queue.

8. The SIOV device of claim 1, wherein the one or more queue policies include a batch sampling policy, and to select the hardware queue based on the batch sampling policy, the scheduling firmware is configured to:
sample a batch of hardware queues;
collect performance metrics from hardware queues in the batch; and
select the hardware queue from the batch of hardware queues based on the performance metrics.

9. The SIOV device of claim 1, wherein the one or more queue policies include a dequeue rate policy, and to select the hardware queue based on the dequeue rate policy, the scheduling firmware is configured to select the hardware queue based on a dequeue rate of the hardware queue exceeding an enqueue rate of the hardware queue by at least a threshold amount.

10. The SIOV device of claim 1, wherein the one or more queue policies include a locality policy, and to select the hardware queue based on the locality policy, the scheduling firmware is configured to select the hardware queue based on a task that is ready for dispatch from the shared work queue being dependent on one or more tasks that have been dispatched to the hardware queue.

11. The SIOV device of claim 1, wherein the shared work queue is a priority queue, and to dispatch the tasks from the shared work queue, the scheduling firmware is configured to dispatch the tasks in an order of priority assigned to the tasks by the priority queue.

12. The SIOV device of claim 1, wherein the shared work queue is a first-in-first-out (FIFO) queue.

13. The SIOV device of claim 1, wherein the shared work queue includes the tasks enqueued in queue order from different software processes that are assigned an order of priority, and to dispatch the tasks from the shared work queue, the scheduling firmware is configured to dispatch the tasks in the order of priority of the different software processes and out of the queue order.

14. A system, comprising:
a scalable input/output virtualization (SIOV) device including multiple shared work queues and multiple hardware queues; and
a host processor to:
communicate one or more dispatch policies and one or more queue policies to the SIOV device, the one or more dispatch policies controlling which shared work queue of the multiple shared work queues from which tasks are dispatched, the one or more queue policies controlling which hardware queue of the multiple hardware queues in which to enqueue the tasks; and
submit the tasks to the multiple shared work queues, thereby directing the SIOV device to dispatch the tasks from the multiple shared work queues to the multiple hardware queues in accordance with the one or more dispatch policies and the one or more queue policies.

15. The system of claim 14, wherein the one or more dispatch policies include a prioritization policy indicating an order of priority assigned to the multiple shared work queues, the prioritization policy instructing the SIOV device to dispatch the tasks from a shared work queue having a highest relative priority among one or more shared work queues having at least one task that is ready for dispatch.

16. The system of claim 14, wherein the one or more dispatch policies include a distribution policy instructing the SIOV device to:
decrement task counters associated with the multiple shared work queues responsive to the tasks being dispatched from the multiple shared work queues;
dispatch the tasks from shared work queues having a non-zero value; and
reset the task counters to a predefined value responsive to the task counters of the multiple shared work queues each being decremented to zero.

17. The system of claim 14, wherein the one or more dispatch policies include a throttling policy instructing the SIOV device to throttle dispatch of the tasks from one or more shared work queues based on a number of in-flight tasks of the one or more shared work queues exceeding a threshold number.

18. The system of claim 14, wherein the host processor includes a compiler configured to generate a task graph including the tasks and dependencies between the tasks, and to submit the tasks, the host processor is configured to submit the task graph directing the SIOV device to schedule the tasks of the task graph based on the dependencies.

19. The system of claim 14, wherein the host processor includes a compiler configured to receive a static task graph including the tasks and dependencies between the tasks, and map the tasks of the static task graph to respective hardware queues based on the dependencies, the one or more queue policies including a compiler-driven policy directing the SIOV device to dispatch the tasks to the respective hardware queues to which the tasks are mapped.

20. A method, comprising:
receiving, by a scalable input/output virtualization (SIOV) device, tasks for submission to multiple shared work queues of the SIOV device;
throttling, by the SIOV device, dispatch of the tasks from at least one shared work queue based on a number of in-flight tasks of the at least one shared work queue exceeding a threshold number;
dispatching, by the SIOV device, the tasks from a non-throttled shared work queue to a hardware queue of the SIOV device; and
dispatching, by the SIOV device, the tasks from the hardware queue to a processing element array of the SIOV device for execution.
